(19) United States
(12) Patent Application Publication
(10) Pub. No.: US 2006/0154649 A1
(43) Pub. Date: Jul. 13, 2006

(54) Transfer of personal data

(76) Inventors: Claus Pedersen, Vallensbaek (DK); Hossein Djelogiry, Fredensborg (DK)

Correspondence Address: HARRINGTON & SMITH, LLP, 4 RESEARCH DRIVE, SHELTON, CT, 06484-6212, US

(21) Appl. No.: 10/537,948

(22) PCT Filed: Dec. 11, 2002
(86) PCT No.: PCT/IB02/05311

§ 371 Date: Jan. 20, 2006

(51) Int. Cl. H04L 12/58

(52) U.S. Cl. 455/412.1

(57) ABSTRACT

A system includes a first mobile device, for initiating the transfer of a personal collection of data and/or settings from the first mobile device to a remote server, a server for setting up sessions and storing collections of data and/or settings; and a second mobile device, for initiating the transfer of the personal collection of data and/or settings from a storage location in the server to the second mobile device. The first mobile device includes first transceiver means arranged to transmit an initiation message to the server for initiating the setting-up of a session between the server and the first mobile device, by the server, for the transfer of a personal collection of data and/or settings between the device and the server. The second mobile device includes first transceiver means arranged to transmit an initiation message to the server for initiating the setting-up of a session between the server and the first mobile device, by the server, for the transfer of the collection of personal data and/or settings between the device and the server.

Embodiments of the present invention relate to the transfer of personal data and settings from a device to a server and the transfer of that personal data to the same or a different device.

In this patent application, the term ‘transfer’ means to move from a source to a target and/or to copy from a source to a target.

There is a current trend towards the personalisation of mobile devices. This can be seen with the development of removable fashion covers for mobile telephones and personal digital assistants that allow the appearance of a device to be personalised. It is also evident in the popularity of personalised audible incoming call alerts, which may be personalised by downloading or composing ring-tones. It is also possible to personalise software applications, for example, by selecting settings and entering or downloading data.

A user of a mobile device may spend a considerable amount of time and effort configuring the device's settings and gathering their own personal collection of data on the device. Other mobile devices appear less attractive to a user because they do not have correctly configured settings and do not contain the user's personal collection of data. The amount of time and effort that is required to recreate the same configuration of settings and the same collection of data on the new device is very great.

It would therefore be desirable to be able to transfer the user's personal collection of data and/or settings from one mobile device to another mobile device.

SyncML™ synchronisation allows data from one device to be copied to another device. However SyncML Synchronisation cannot be used for all types of data.

SyncML™ Device Management (DM) is an open, universal industry standard. It gives third parties, such as service providers and corporate information management departments, the ability to carry out difficult configuration procedures for mobile terminals on behalf of the users. The service provider or corporate information department can therefore enforce a configuration on a plurality of mobile terminals very easily. This allows the setting of software parameters, remote trouble shooting and installing and upgrading software. However, SyncML DM is generally used for the configuration of multiple terminals at a time and the process is initiated on the server side by the third party.

According to one aspect of the present invention there is provided a mobile device, for initiating the transfer of a personal collection of data and/or settings to/from a remote server, comprising: transceiver means arranged to transmit an initiation message to the server for initiating the setting-up of a session between the server and the device, by the server, for the transfer of a personal collection of data and/or settings between the device and the server. The session may be a SyncML DM session.

According to another aspect of the present invention there is provided a server, for transferring a user's collection of personal data and/or settings to/from a remote device, comprising: transceiver means for communicating with a remote device identified in a received initiation message, to set-up a session between the server and the identified device for the transfer of a personal collection of data and/or settings between the device and the server. The session may be a SyncML DM session. According to a further aspect of the present invention there is provided a system comprising a first mobile device, for initiating the transfer of a personal collection of data and/or settings from the first mobile device to a remote server, comprising first transceiver means arranged to transmit an initiation message to the server for initiating the setting-up of a session between the server and the first mobile device, by the server, for the transfer of a personal collection of data and/or settings between the device and the server; a server for setting up sessions and storing collections of data and/or settings; and a second mobile device, for initiating the transfer of a personal collection of data and/or settings from a storage location in the server to the second mobile device, comprising first transceiver means arranged to transmit an initiation message to the server for initiating the setting-up of a session between the server and the first mobile device, by the server, for the transfer of the collection of personal data and/or settings between the device and the server. The sessions may be a SyncML DM sessions.

According to a still further aspect of the present invention there is provided a method of personalizing a second device comprising the steps of: uploading a personal collection of data and settings from a first device to a server for storage; and downloading a stored personal collection of data and settings from the server to a second device.

For a better understanding of the present invention reference will now be made by way of example only to the accompanying drawings in which:

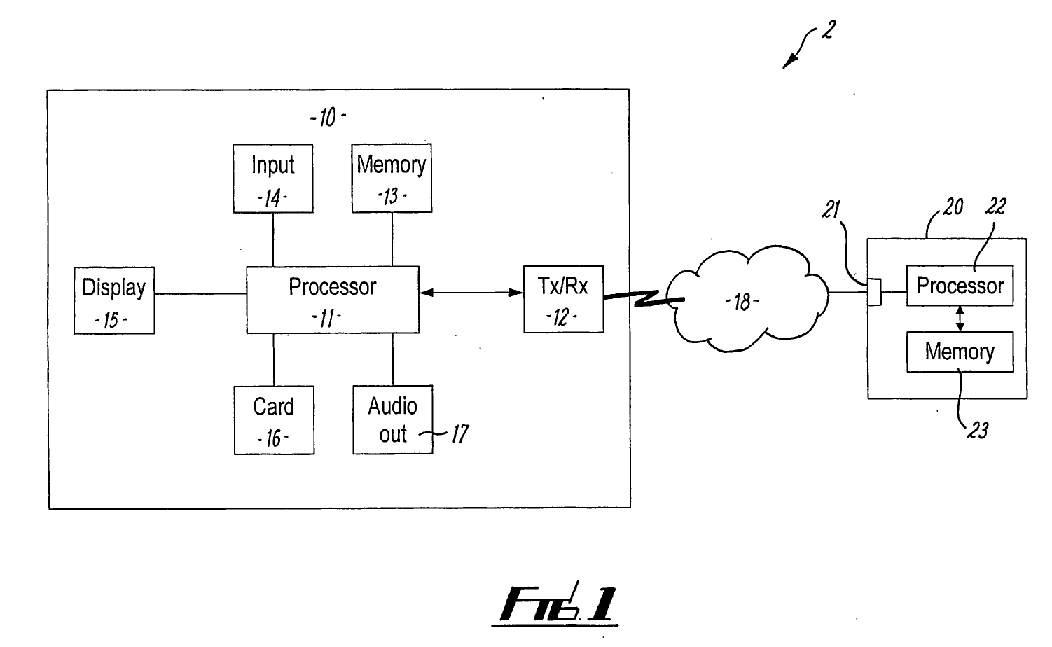

FIG. 1 illustrates client-server system comprising a mobile device communicating with a server 20;

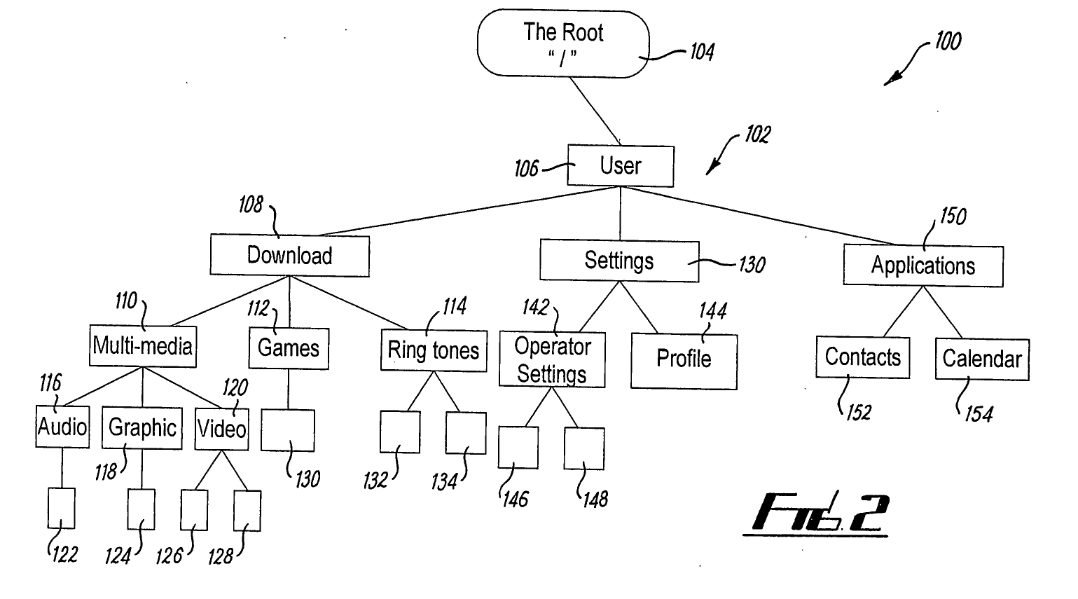

FIG. 2 illustrates a management tree data structure;

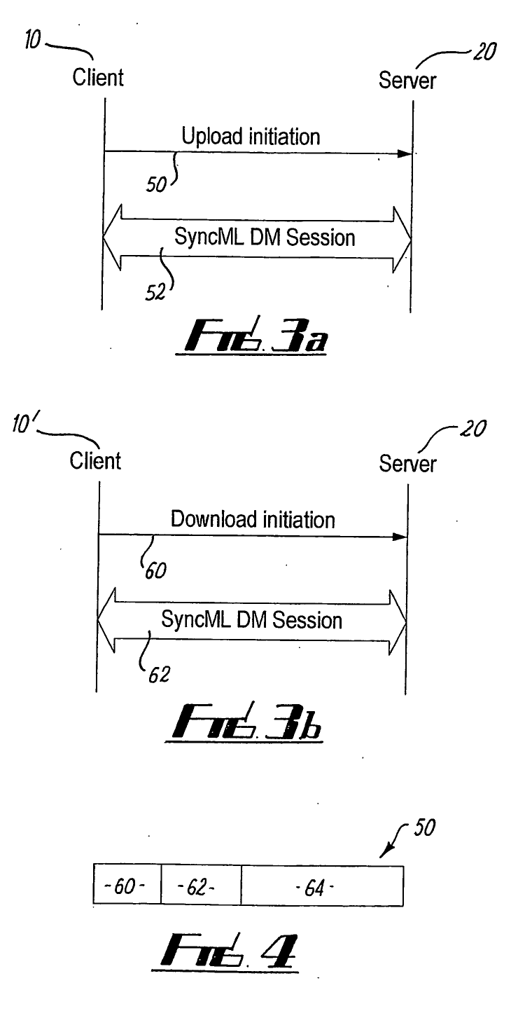

FIG. 3a is a signaling diagram for upload of a personal collection of data and settings;

FIG. 3b is a signaling diagram for download of a personal collection of data and settings; and

FIG. 4 schematically illustrates the content of the upload initiation message 50.

FIG. 1 illustrates a client-server system 2 comprising a mobile device 10 communicating via a cellular telephone network 18 with a server 20. The mobile device 10, in this embodiment a mobile telephone, comprises: a processor 11, a cellular radio transceiver 12, a memory 13, an input device 14 e.g. a keypad, a display 15, a smart card 16 and an audio output device 17.

The processor 11 controls the mobile telephone 10. It is connected to write to and read from the memory 13. It receives input data from the keypad 14 and provides output data to the display 15 and audio output device 17. It controls the cellular radio transceiver so that it can communicate in the cellular telephone network 18 which may be, for example, a GSM or WCDMA network; The processor is also connected to the smart card 16, which at least provides user identification information to the processor such as the user's telephone number or IMSI. The operation of the processor 11 is controlled by software stored in the memory 13 and loaded into the processor. In operation, the processor receives and transmits data via the transceiver 12 and writes and reads data from the memory 13.

The server 20 comprises an input/output interface 21 connected to the cellular radio network 18 either directly or indirectly, a processor 22 and a memory 23. The server 20 is a SyncML DM server. It issues SyncML DM commands to the mobile telephone 10 via the input/output interface 21 and correctly interprets responses from the mobile telephone 10.

In the mobile telephone 10, processor 11 operates as a management client (MC) and maintains a management tree data structure 100 in the memory 13. The MC correctly interprets SyncML DM commands received from the server, executes appropriate actions in the mobile telephone 10 and sends back relevant responses to the issuing management server via the transceiver 12.

The management tree 100 (FIG. 2) is a mechanism by which the management client interacts with the mobile telephone 10. The MC may store or retrieve values from the tree and manipulate the properties of the tree. The management tree has nodes connected by branches. Each node can be uniquely addressed by a URI. A node may be an interior node which may have any number of child (dependent) nodes, but cannot store any value or a node may be a leaf node, which cannot have child (dependent) nodes but can store a value. A value may be a string, a file, a number etc. The nodes can be manipulated by the MC.

The management tree 100 of the present embodiment, illustrated in FIG. 2. differs from the management tree defined in SyncML Device Management Tree and Description, v1.1.1, Oct. 2, 2002, in that it has a new, additional management object 102 (a personal or user management object). The additional user management object 102 is a sub-tree off the root 104. The sub-tree 102 starts with a ‘user’ interior node 106 depending from the root interior node 104.

The collection of personal data and settings defined by the user management object 102, has three distinct sets of data/settings—downloaded data included in the sub-tree depending from the ‘download’ node 108, settings included in the sub-tree depending from the ‘settings’ node 130 and application data included in the sub-tree depending from the ‘applications’ node 150. These sets of data and the consequent structure of the user management object 102 are merely illustrative.

A ‘download’ node 108 depends from ‘user’ node 106 and defines a user management object for downloaded data. The ‘download’ node 108 has three dependent nodes ‘multi-media’ 110, ‘games’ 112 and ‘ring-tones’ 114.

In this example, the ‘multi-media’ node 110 has three dependent nodes ‘audio’ 116, ‘graphic’ 118 and ‘video’ 120. The ‘audio’ node 116 has a single leaf node 122 the value of which is an audio file. This file may be used to reproduce sounds via the audio output device 17 of a mobile telephone 10. The ‘graphic’ node 118 has a single leaf node 124 the value of which is a graphic file. This file may be used to reproduce an image on the display 15 of the mobile telephone 10. It may have been taken by a camera attached to or integrated with the mobile telephone or may have been downloaded via the internet, for example, using WAP. The ‘video’ node 120 has two leaf nodes 126 and 128 each of which has a different video file as its value. Each of the video files may be used to reproduce a video sequence on the display of a mobile telephone. They may have been captured by a camera attached to or integrated with the mobile telephone 10 or downloaded via the internet.

The ‘games’ node 112 has a single leaf node 130 the value of which is a game application e.g. ‘Snake™’ and the ‘ring-tone’ node 114 has two leaf nodes 132 and 134 each of which has as its value a ringing-tone file for controlling the incoming call alert of the mobile telephone 10. The game, in this example, is a Java application previously downloaded via the internet and the ringing tones were previously selected and paid for by the user and delivered via SMS messages.

A ‘settings’ node 130 also depends from the ‘user’ node 106. It has a dependent ‘operator settings’ node 142 and a dependent leaf node 144. The dependent leaf node 144 has as its value the user phone profile of the mobile phone 10. It defines the settings selected by a user for e.g. incoming call alert, volume of incoming call alert, active call diversions, incoming message alert etc. The ‘operator settings’ node 142 has two dependent leaf nodes 146 and 148, which respectively define the WAP settings and the email settings which allow a mobile telephone to communicate using WAP and email, respectively, via the cellular telephone network 18.

An ‘applications’ node 150 also depends from the ‘user’ node 106. It has two leaf nodes 152 and 154 which respectively define the telephone user's contacts and the telephone user's calendar. The leaf node 152 has as its value the names and telephone numbers (and also possibly the email addresses and mail addresses) of the people with whom the user is in contact. The leaf node 154 has as its value the appointments and entries the user has made in the calendar of the mobile telephone 10

Therefore the collection of private data and data is defined by the user management object 102. Each piece of personal data/personal setting is associated with a separate one of the leaf nodes 122, 124, 126, 128, 130, 132, 134, 146, 148, 144, 152 & 154.

New nodes can be created (e.g. download an audio file) and the values at certain leaf nodes can be changed (e.g. change the user's phone profile). As values are created and changed the user management object 102 is updated. This is possible as there is synchronous run time access to the leaf nodes and interior nodes.

The above described management tree is merely illustrative. It may have a different structure and content, but will always be a hierarchical nodular data structure.

Upload

The uploading of the collection of private data and settings from a mobile telephone 10 to a server 20 is illustrated in FIG. 3a. The mobile telephone 10, in response to a user actuation, sends an upload initiation message 50 to the server 20. The server 20 then initiates a SyncML Data Management (DM) Session 52. The DM session 52 is used to transfer the sub-tree structure 102 to the server 20.

The initiation message 50, illustrated in FIG. 4, comprises: a PIN code 60, data ID 62, and user ID 64. The PIN code 60 is included for security. The data ID 62 identifies the data which the server 20 should retrieve from the mobile telephone 10 during the DM session 52 initiated by the upload initiation message 50. The user ID 64 identifies the user of the mobile telephone or the mobile telephone itself so that the server 20 can initiate the DM session 52 with the correct mobile telephone 10.

To initiate uploading of a user's collection of personal data and settings, the user selects the “upload personal data” option from the mobile telephone's menu. The menu gives the user two options—“upload all” and “selective upload”. Selecting “upload all” results in the data ID 62 being set to “./user”. This identifies the starting node of the user management object 102 defining the user's collection of personal data and settings. Selecting “selective upload” results in the user management object 102 being presented as a menu structure to the user, who can then use the menu to navigate through the tree-structure of the user management object 102. The menu initially starts with the menu positioned at the ‘user’ node 102. The menu displays as selectable options for the user the connected nodes in the lower hierarchical level of the tree-structure. The menu would present three options “download”, “settings” and “applications”. Selecting an option positions the menu at the corresponding node. The user may navigate deeper into the tree-structure by selecting one of the displayed options to move the menu to one of the connected nodes in the lower hierarchical level or the user may return to the connected node in the upper hierarchical level. When the menu is positioned at the desired node, the user selects that node as the data ID. The selecting of a menu option corresponding to an interior node will result in the uploading of the management tree structure that depends from that node. If for example, “download” is chosen, the data ID 62 for the upload initiation message 50 is set to ”./user/download”, whereas if “ring-tones” and “games” were chosen it would be “./user/download/games; ./user/download/ring-tones”.

Once the data has been selected, the user is requested by the mobile telephone 10 via the display 15 to enter a PIN code 60 via the mobile telephone's keypad 14. The mobile telephone 10 then automatically includes the user ID 64, which is typically the phone number of the mobile telephone. The upload initiation message 50 including the PIN code 60, user ID 64 and data ID 62 is then sent to the server 20.

The upload initiation message 50 may be sent by any suitable means such as in a Short Message Service (SMS) message or, if the device is a personal digital assistant without mobile telephone capabilities via IR or Bluetooth.

The server 20 maintains a database in the memory 23. The processor 22 creates a record in the database using the user ID 64 received in the upload initiation message 102 and the record is secured using the PIN code 60 received in the upload initiation message 102. This record is used to store the user management object 102 (or a part of it) that includes the user's collection of personal data and settings.

The server initiates the DM session 52 using the procedure described in SyncML Device Management Tree and Description, v1.1.1 and obtains the collection of personal data and settings using the ‘Get’ command. The ‘Get’ command is formatted in XML. If the data ED 62 has a format “X”, then suitable format is for the ‘Get’ command is:

<Get>

<CmdID> 4 </CmdID>
<Item>

<Target>

<LocURI> X ?list=StructData</LocURI>

</Target>

</Item>

</Get>

The MC of the mobile telephone 10 responds to the ‘Get’ command using <Result> including multiple <Item> elements. Each <Item> defines the location of a node using a <source> element and the value of that node, if any, using a <data> element.

Although the sending of the upload initiation message 50 is described as in response to the user action, in alternative embodiments it may be sent automatically e.g. on changing the SIM card 16.

Download

The user's personal collection of data and settings can be downloaded from the server 20 to the same mobile telephone 10 at a later time or to a different mobile device 10′ then or at a later time. The server 20 may therefore be used to back-up the user's personal collection of data and settings or as an intermediary in copying the user's collection of data and settings to a new device.

The process of downloading a user's collection of data and settings is illustrated in FIG. 3b. A second mobile device 10′ sends a download initiation message 60 to the server 20. The server 20 then initiates a SyncML Data Management (DM) Session 62. The DM session 62 is used to transfer the user management object 102, or a part of it, stored in the relevant database record to the mobile device 10′.

The download initiation message 60 comprises: a PIN code 60 and user ID 64. The PIN 60 is included for security. The user ID 64 identifies the user of the mobile telephone or the mobile telephone 10′ itself so that the server 20 can initiate the DM session 62 with the correct mobile telephone 10′.

To initiate downloading a user's collection of personal data and settings, the user selects the “download personal data” option from the menu of the mobile telephone 10′. The user is requested to enter a PIN code 60 via the mobile telephone's keypad 14. The mobile telephone 10′ then automatically includes the user ID 64, which is typically the phone number of the mobile telephone 10′. The download initiation message 60 is then sent to the server 20.

The download initiation message 60 may be sent by any suitable means such as a Short Message Service (SMS) message or, if the device is a personal digital assistant without mobile telephone capabilities via IR or Bluetooth.

The server 20, checks the PIN code 60 in the download initiation message 60 against the PIN code securing the record, in the server's database, corresponding to the user ID 64. If there is not agreement, an error message is returned to the client 10′.

If there is agreement, the record is accessed. The server 20 then initiates a DM session 62 using the procedure described in SyncML Device Management Tree and Description, v1.1.1. It obtains the collection of personal data and settings from the accessed record, processes it and sends it to the mobile telephone 10′ using the ‘Add’ command.

The data stored in the record has the (X)ML) format: <Result> including multiple <Item> elements (one for each node). Each <Item> defines the location of its node using a <source> element and the value of that node, if any, using a <data> element.

The ‘Add’ command is formatted in XML. The Add command has the format <Add> including multiple <Item> elements (one for each node). Each <Item> element defines at least the location of its node using a <target> element and the value of that node, if any, using a <data> element.

The Add command is created from the stored record by converting the stored <Item> elements into <Item> elements for the Add command. This involves converting the <source> element into the target element of the Add command without changing the location of the node. This is achieved by replacing “<Source>” with “<Target>” and “</Source>” with “</Target>”.

Although, the sending of the download initiation message 60 has been described as a result of user actuation, in other embodiments, it may be sent automatically. In one advantageous embodiment, the mobile telephone 10 senses when a new smart (SIM) card 16 has been inserted, and in response sends the download initiation message 60. Each smart (SIM card 16 carries a unique identifier. The insertion of a new smart card 16 can be sensed by storing the unique identifier of the smart card 16 in a non-volatile memory when the mobile telephone 10 is switched off and then comparing the stored value with a value read from the smart card 16 that is present when the telephone 10 is switched on. If the values are the same the smart card 16 has not been changed. If they are different the smart card 16 has been changed.

An issue arises in the above described process for recreating a user's personal collection of data on another device. Some of that data may be protected by copyright and the user may not have a licence to create multiple copies. In order to avoid issues of copyright infringement, in one embodiment copyrighted material will not be copied from the fist mobile telephone 10 to the server 20 and then from the server 20 to the second mobile telephone 10′ but will, instead, be moved from the first mobile telephone 10 to the server 20 and then moved from the server 20 to the second mobile telephone 10′. This is achieved by the combination of a copy command which transfers values from the source to the target with a delete command which removes the values in the source.

Thus in the above described process copyrighted material assigned to a particular value is identified as such by the value. The MC processes the values to be copied to the server 20 using the ‘Get’ command and identifies those relating to copyrighted material. After the values of copyrighted material have been copied to the server 20, the original node containing that value is deleted.

As a variation to this process, a single back-up copy of the copyrighted material is allowed to be made on the server 20, but it cannot subsequently be transferred to another device until the original version in the first device has been deleted.

Although embodiments of the present invention have been described in the preceding paragraphs with reference to various examples, it should be appreciated that modifications to the examples given can be made without departing from the scope of the invention as claimed. For example although described with reference to a mobile phone, it should be appreciated that the present invention can find application in any user configurable device which has an input/output means for communicating with the server 20. It has particular application in mobile devices such as mobile telephones and personal digital assistants, but may also find application in personal computers, for example.

Whilst endeavouring in the foregoing specification to draw attention to those features of the invention believed to be of particular importance it should be understood that the Applicant claims protection in respect of any patentable feature or combination of features hereinbefore referred to and/or shown in the drawings whether or not particular emphasis has been placed thereon.

1. A mobile device, for initiating the transfer of a personal collection of data and/or settings to/from a remote server, comprising:
transceiver means arranged to transmit an initiation message to the server for initiating the setting-up of a session between the server and the device, by the server, for the transfer of a personal collection of data and/or settings between the device and the server.

2. A mobile device as claimed in claim 1, further comprising:
a memory for storing a data structure organised as a hierarchical management tree comprising a user management object defining the personal collection of data and/or settings, wherein the management object is a hierarchical tree structure comprising leaf nodes, defining in combination the personal collection of data and/or settings, and interior nodes, wherein each interior node and each leaf node depends from a single interior node and each leaf node has a value representing a portion of the personal collection of data and or settings; and
control means for adapting the structure and content of the user management object.

3. A mobile device as claimed in claim 2, wherein the personal collection of data and/or settings is transferred or copied as a description of the user management object or a portion of the user management object.

4. A mobile device as claimed in claim 2, arranged to create a hierarchical menu structure from the user management object by which a user can navigate to selectable options.

5. A mobile device as claimed in claim 1, wherein the initiation message is an upload initiation message for initiating the setting-up of a session between the server and the device, by the server, for the transfer of a personal collection of data and/or settings from the device to the server, the upload initiation message comprising a parameter identifying the data to be uploaded and a parameter identifying the user.

6. A mobile device as claimed in claim 5, wherein the upload initiation message further comprises a parameter identifying a PIN code.

7. A mobile device as claimed in claim 6, further comprising a user input for entry of the PIN code.

8. A mobile device as claimed in claim 5, wherein the parameter identifying the data to be uploaded identifies a node of a data structure organised as a hierarchical nodular tree structure.

9. A mobile device as claimed in claim 1, further comprising a memory for storing a data structure organised as a hierarchical management tree comprising a user management object defining the personal collection of data and/or settings,
wherein the management object is a hierarchical tree structure comprising leaf nodes, defining in combination the personal collection of data and/or settings, and interior nodes,
wherein each interior node and each leaf node depends from a single interior node and each leaf node has a value representing a portion of the personal collection of data and or settings; and control means for adapting the structure and content of the user management object, arranged to create a hierarchical menu structure from the user management object by which a user can navigate to selectable options,
wherein the initiation message is an upload initiation message for initiating the setting-up of a session between the server and the device, by the server, for the transfer of a personal collection of data and/or settings from the device to the server, the upload initiation message comprising a parameter identifying the data to be uploaded and a parameter identifying the user,
wherein the parameter identifying the data to be uploaded identifies a node of a data structure organised as a hierarchical nodular tree structure, and
wherein the menu enables the user selection of the identified node.

10. A mobile device as claimed in any one of claim 5, wherein the parameter identifying the user is provided automatically, without user intervention, by the device.

11. A mobile device as claimed in claim 1, wherein the initiation message is a download initiation message for initiating the setting-up of a session between the server and the device, by the server, for the transfer of a personal collection of data and/or settings from the server to the device, the upload initiation message comprising a parameter identifying the user.

12. A mobile device as claimed in claim 11, wherein the upload initiation message further comprises a parameter identifying a PIN code.

13. A mobile device as claimed in claim 12, further comprising a user input for entry of the PIN code.

14. A mobile device as claimed in claim 11, wherein the parameter identifying the user is provided automatically, without user intervention, by the device.

15. A mobile device as claimed in claim 1, arranged to transfer first portions of the personal collection of data and/or settings by copying; and to transfer second portions of the personal collection of data by moving.

16. A mobile device as claimed in claim 1 arranged to receive a smart card, wherein the device comprises detection means for detecting when the received smart card is changed, and control means, responsive to the detection of the change of a smart card by the detection means, to control the transceiver means to transmit an initiation message to the server.

17. A server, for transferring a user's collection of personal data and/or settings to/from a remote device, comprising:
transceiver means for communicating with a remote device identified in a received initiation message, to set-up a session between the server and the identified device for the transfer of a personal collection of data and/or settings between the device and the server.

18. A server as claimed in claim 17, comprising a memory storing a database, wherein the server is responsive to a received initiation message, identifying data to be uploaded and the user of the device, to create a record in the database for the identified user.

19. A server as claimed in claim 18, wherein the received initiation message further identifies a PIN code, the server being arranged to secure the created record using the PIN code.

20. A server as claimed in claim 18, wherein the server issues a command to the device, during the session between the server and the device, identifying the data to be uploaded.

21. A server as claimed in claim 20, wherein the command identifies a node of a data structure organised as a hierarchical nodular tree structure.

22. A server as claimed in claim 18, wherein the created database record stores a description of a hierarchical nodular tree structure, that includes the user's personal collection of data and/or settings, received from the device during the session.

23. A server as claimed in claim 17, comprising a memory storing a database, wherein the server is responsive to a received download initiation message, identifying the user of the device, to access a record in the database for the identified user.

24. A server as claimed in claim 23, wherein the access to the record is conditional upon a PIN code included in the download initiation message.

25. A server as claimed in claim 23, wherein the accessed record stores a description of a hierarchical nodular tree structure that includes that user's personal collection of data and/or settings and the server is arranged to transfer the description to the device during the session.

26. A system comprising:
a first mobile device, for initiating the transfer of a personal collection of data and/or settings from the first mobile device to a remote server, comprising first transceiver means arranged to transmit an initiation message to the server for initiating the setting-up of a session between the server and the first mobile device, by the server, for the transfer of a personal collection of data and/or settings between the device and the server;
a server for setting up sessions and storing collections of data and/or settings; and
a second mobile device, for initiating the transfer of a personal collection of data and/or settings from a storage location in the server to the second mobile device, comprising first transceiver means arranged to transmit an initiation message to the server for initiating the setting-up of a session between the server and the first mobile device, by the server, for the transfer of the collection of personal data and/or settings between the device and the server.

27. A data structure organised as a hierarchical management tree comprising a user management object defining a personal collection of data and/or settings, wherein the management object is a hierarchical tree structure comprising leaf nodes, defining in combination the personal collection of data and/or settings, and interior nodes, wherein each interior node and each leaf node depends from a single interior node and each leaf node has a value representing a portion of the personal collection of data and or settings.

28. A data structure as claimed in claim 27, further comprising a root node wherein the user management object depends from the root node and a plurality of other management objects depend from the root node.

29. The use of a data structure as claimed in claim 27, to create a hierarchical menu structure representing the user's personal collection of data and/or settings.

30. A method of personalizing a second device comprising the steps of:
uploading a personal collection of data and settings from a first device to a server for storage; and
downloading a stored personal collection of data and settings from the server to a second device.

31. (canceled)

32. (canceled)
